(19) United States
(12) Patent Application Publication
(10) Pub. No.: US 2022/0251356 A1
(43) Pub. Date: Aug. 11, 2022

(54) FLAME-RETARDANT RESIN COMPOSITION, MOLDED ARTICLE, AND TOILET SEAT

(71) Applicant: IDEMITSU FINE COMPOSITES CO.,LTD., Tokyo (JP)

(72) Inventors: Shigeru MAEYAMA, Sodegaura-shi (JP); Kazuki FUJITA, Sodegaura-shi (JP)

(73) Assignee: IDEMITSU FINE COMPOSITES CO.,LTD., Tokyo (JP)

(21) Appl. No.: 17/629,191

(22) PCT Filed: Jul. 21, 2020
(86) PCT No.: PCT/JP2020/028266

§ 371 Date: Jan. 21, 2022

(30) Foreign Application Priority Data
Aug. 2, 2019 (JP) 2019-142971

(51) Int. Cl. C08L 23/12; C08L 53/00

(52) U.S. Cl. CPC C08L 23/12; C08L 53/00; C08L 2201/02; A47K 13/02; C08L 2205/03; C08L 2207/32; C08L 2201/08

(57) ABSTRACT

A flame-retardant resin composition, comprising the following components (A) to (D), wherein the content of the component (B) is 1 part by mass or more and 30 parts by mass or less based on 100 parts by mass of the component (A), the content of the component (C) is 1.5 parts by mass or more and 10 parts by mass or less based on 100 parts by mass of the component (A), and the content of the component (D) is 1 part by mass or more and 10 parts by mass or less based on 100 parts by mass of the component (A): (A) polypropylene (B) a brominated flame-retardant having isocyanurate structure (C) a pigment (D) a flame-retardant synergist

### TECHNICAL FIELD

The invention relates to a flame-retardant resin composition, a molded body, and a toilet seat.

### BACKGROUND ART

Polyolefin has been used in a wide range of fields as molding materials because of its excellent properties.

However, polyolefin is flammable, so that flame retardancy is often required for polyolefin when used as an industrial material.

A resin composition obtained by making polyolefin to be retardant has been proposed (see, for example, Patent Documents 1 and 2).

### RELATED ART DOCUMENTS

### Patent Documents

[Patent Document 1] JP 2002-234964 A1

[Patent Document 2] JP 2013-227409 A

### SUMMARY OF THE INVENTION

It is an object of the invention to provide a flame-retardant resin composition capable of forming a molded body having sufficient flame retardancy and excellent light resistance, a molded body, and a toilet seat.

The inventors noticed that conventional resin compositions do not have sufficient light resistance and that the resin deteriorates when treated with UV light in order for antibacterial and bactericidal treatments.

As a result of extensive studies, the inventors found that both of sufficient flame retardancy and excellent light resistance can be given to a resin composition by a specific combination of the components, thereby completing the invention.

According to the invention, the following flame-retardant resin composition and so on are provided.

1. Aflame-retardant resin composition, comprising the following components (A) to (D), wherein

the content of the component (B) is 1 part by mass or more and 30 parts by mass or less based on 100 parts by mass of the component (A),

the content of the component (C) is 1.5 parts by mass or more and 10 parts by mass or less based on 100 parts by mass of the component (A), and

the content of the component (D) is 1 part by mass or more and 10 parts by mass or less based on 100 parts by mass of the component (A):

(A) polypropylene
(B) a brominated flame-retardant having an isocyanurate structure
(C) a pigment
(D) a flame-retardant synergist.
2. The flame-retardant resin composition according to 1, further comprising (E1) a hindered amine light stabilizer.
3. The flame-retardant resin composition according to 1 or 2, further comprising (E2) an ultraviolet absorber.
4. The flame-retardant resin composition according to any one of 1 to 3, further comprising (F) a water repellent.
5. The flame-retardant resin composition according to 4, wherein the component (F) is a mixture of polypropylene and a silicone oil.
6. The flame-retardant resin composition according to any one of 1 to 5, further comprising a brominated flame-retardant other than the component (B).
7. The flame-retardant resin composition according to 6, wherein a value obtained by dividing the content of the component (B) by the content of the brominated flame-retardant other than the component (B) is 1 or larger and 30 or smaller.
8. The flame-retardant resin composition according to 6 or 7, wherein the content of the brominated flame-retardant other than the component (B) is 1 part by mass or more and 30 parts by mass or less based on 100 parts by mass of the component (A).
9. The flame-retardant resin composition according to any one of 6 to 8, wherein the content of bromine in the brominated flame-retardant other than the component (B) is 45% by mass or more and 80% by mass or less based on 100% by mass of the entire brominated flame-retardant other than the component (B).
10. The flame-retardant resin composition according to any one of 6 to 9, wherein the brominated flame-retardant other than the component (B) is tetrabromobisphenol-A-bis(2,3-dibromopropylether).
11. The flame-retardant resin composition according to any one of 1 to 10, wherein a melt flow rate of the component (A) measaured at a condition of 230° C. and 2.16 kg is 1 g/10 min or lager and 60 g/10 min or smaller.
12. The flame-retardant resin composition according to any one of 1 to 11, wherein the component (A) comprises homopolypropylene and a propylene-ethylene copolymer.
13. The flame-retardant resin composition according to any one of 1 to 12, wherein the content of the component (B) is 10 parts by mass or more and 30 parts by mass or less based on 100 parts by mass of the component (A).
14. The flame-retardant resin composition according to any one of 1 to 13, wherein the content of bromine in the component (B) is 45% by mass or more and 80% by mass or less based on 100% by mass of the entire component (B).
15. The flame-retardant resin composition according to any one of 1 to 14, wherein the component (B) is tris(2,3-dibromopropyl)isocyanurate.
16. A molded body produced by using the flame-retardant resin composition according to any one of 1 to 15.
17. A toilet seat comprising the molded body according to 16.

According to the invention, it is possible to provide a flame-retardant resin composition capable of forming a molded body having sufficient flame retardancy and excellent light resistance, a molded body, and a toilet seat.

### DESCRIPTION OF EMBODIMENTS

In this specification, “x to y” represents “x or more and y or less.”

In this specification, the preferred provisions can be arbitrarily adopted, and combinations of the preferred provisions are more preferable. One preferred provision may be employed in combination with one or two or more other preferred provisions.

Additional constituent requirements may be arbitrary adopted to the extent that they do not impair the effect of the invention.

The flame-retardant resin composition according to one aspect of the invention contains the following components (A) to (D), wherein

the content of the component (B) is 1 part by mass or more and 30 parts by mass or less (preferably 2 to 20 parts by mass, more preferably 3 to 15 parts by mass, still more preferably 4 to 10 parts by mass, particularly preferably 5 to 8 parts by mass, from the viewpoint of balance between flame retardancy and light resistance) based on 100 parts by mass of the component (A),

the content of the component (C) is 1.5 parts by mass or more and 10 parts by mass or less (preferably 2 to 8 parts by mass, more preferably 3 to 7 parts by mass, and still more preferably 4 to 6 parts by mass, from the viewpoint of light resistance) based on 100 parts by mass of the component (A),

the content of component (D) is 1 part by mass or more and 10 parts by mass or less (preferably 2 to 7 parts by mass, more preferably 3 to 5 parts by mass, and still more preferably 3.5 to 4.0 parts by mass, from the viewpoint of flame retardancy) based on 100 parts by mass of the component (A).

(A) polypropylene (hereinafter also referred to as a “component (A)”)
(B) a brominated flame-retardant having isocyanurate structure (hereinafter also referred to as a “component (B)”)
(C) a pigment (hereinafter also referred to as a “component (C)”)
(D) a flame-retardant synergist (hereinafter also referred to as a “component (D)”)

This configuration of the resin composition enables the formation of a molded body having sufficient flame retardancy and excellent light resistance.

As an arbitrary effect, a molded body excellent in water repellency can be formed.

As an arbitrary effect, the moldability can be increased.

As an arbitrary effect, a molded body having excellent balance between rigidity and impact resistance can be formed.

Polypropylene of the component (A) is a polymer containing at least propylene. Specific examples thereof include homopolypropylene, a copolymer of propylene and olefin (e.g., a propylene-ethylene copolymer), and the like.

The component (A) is preferably unmodified polypropylene.

Here, “unmodified” means that the compound of interest has no substituents other than the structure composed of the basic units, and “unmodified polypropylene” is polypropylene having no substituent.

Examples of the unmodified polypropylene include polypropylene having no polar group such as maleic acid.

From the viewpoint of moldability, a melt flow rate (MFR) of the component (A) measured at a condition of 230° C. and 2.16 kg is preferably 1 g/10 min or larger and 60 g/10 min or smaller, more preferably 10 to 55 g/10 min, still more preferably 20 to 50 g/10 min, particularly preferably 30 to 45 g/10 min, and most preferably 35 to 40 g/10 min.

The MFR of the component (A) is measured according to ASTM D-1238 (2013) at a condition of 230° C. and 2.16 kg.

The component (A) may be used alone or in combination of two or more.

From the viewpoint of balance between rigidity and impact resistance, the component (A) preferably contains homopolypropylene and a propylene-ethylene copolymer.

In a mass ratio of homopolypropylene and a propylene-ethylene copolymer, homopolypropylene/propylene-ethylene copolymer is preferably 100/0 to 0/100, more preferably 90/10 to 10/90, still more preferably 80/20 to 20/80, particularly preferably 75/25 to 25/75, and most preferably 70/30 to 30/70, from the viewpoint of balance between rigidity and impact resistance.

One embodiment of the flame-retardant resin composition of the invention contains a component (B). Since the component (B) itself does not undergo a color change, it is possible to suppress the influence on the light resistance.

As the component (B), tris(2,3-dibromopropyl)isocyanurate is preferred.

In the component (B), the content of bromine is preferably 45% by mass or more and 80% by mass or less, more preferably 65 to 70% by mass, based on 100% by mass of the entire component (B), from the viewpoint of flame retardancy and light resistance.

The content of bromine in the component (B) was obtained by determining the structural formula of the component (B) and calculating based on the molecular weight of the determined structural formula.

The component (B) may be used alone or in combination of two or more.

One embodiment of the flame-retardant resin composition of the invention contains a component (C). The component (C) can block ultraviolet rays and suppress degradation of the component (A). The component (C) can absorb radicals and suppress degradation of the component (A).

The component (C) has a function of suppressing deterioration of the resin by blocking ultraviolet rays, and is preferably an inorganic pigment.

Examples of the inorganic pigment include TiO₂, carbon black, iron oxide, chromium oxide, zinc oxide, and the like. In particular, TiO₂ is preferred.

The component (C) may be used alone or in combination of two or more.

Examples of the component (D) include diantimony trioxide, diantimony pentoxide, and the like. From the viewpoint of flame retardancy, diantimony trioxide is preferred.

The component (D) may be used alone or in combination of two or more.

From the viewpoint of light resistance, one embodiment of the flame-retardant resin composition of the invention preferably further contains (E1) a hindered amine light stabilizer (hereinafter, also referred to as a “component (E1)”).

The component (E1) may be used alone or in combination of two or more.

When the component (E1) is contained, the content of the component (E1) is preferably 0.1 to 5.0 parts by mass, more preferably 0.2 to 3.0 parts by mass, still more preferably 0.3 to 1.0 parts by mass, and particularly preferably 0.35 to 0.5 parts by mass, based on 100 parts by mass of the component (A) from the viewpoint of light resistance.

From the viewpoint of light resistance, one embodiment of the flame-retardant resin composition of the invention preferably further contains (E2) an ultraviolet absorber (hereinafter, also referred to as a “component (E2)”).

It is preferable that the component (E2) contain one or more compounds selected from the group consisting of benzotriazole, benzophenone, triazine, and benzoate compounds.

The component (E2) more preferably contains a benzoate compound, and still more preferably contains a 3,5-di-t-butyl-4-hydroxybenzoic acid hexadecyl ester.

The component (E2) may be used alone or in combination of two or more.

When the component (E2) is contained, the content of the component (E2) is preferably 0.1 to 5.0 parts by mass, more preferably 0.2 to 3.0 parts by mass, still more preferably 0.3 to 1.0 parts by mass, and particularly preferably 0.5 to 0.7 parts by mass, based on 100 parts by mass of the component (A) from the viewpoint of light resistance.

From the viewpoint of water repellency, one embodiment of the flame-retardant resin composition of the invention preferably further contains (F) a water repellent.

The component (F) is preferably a mixture (kneaded product) of polypropylene and a silicone oil.

Examples of polypropylene include the same as those of the above-described polypropylene.

When the component (F) is a mixture of polypropylene and a silicone oil, the mass ratio of polypropylene and a silicone oil, polypropylene/silicone oil, is preferably 70/30 to 30/70, more preferably 60/40 to 40/60.

The component (F) suppresses deterioration of flame retardancy and allows water repellency to be easily exhibited.

The silicone oil is an oil composed of, for example, a combination of chlorosilanes produced by a direct process, and refers to a straight silicone oil having, for example, a methyl group or a phenyl group as a substituent or having no substituent.

It is preferable that the silicone oil contain a siloxane bond. Further, the silicone oil is preferably a linear polysiloxane.

Examples of the silicone oil include a low molecular weight oily silicone oil, a high molecular weight silicone oil called gum (e.g., BY27-001 described later). Specifically, examples of the silicone oil include a waxy or oily silicone oil having the number of siloxane bonds of less than 2000, and a gummy silicone oil having the number of siloxane bonds of 2000 to 10000.

The silicone oil is preferably an unmodified silicone oil.

Examples of the unmodified silicone oil include straight silicone oils such as a dimethyl silicone oil (for example, BY27-001 described later), a methylphenyl silicone oil, a methylhydrogen silicone oil, and the like.

The modified silicone oil is silicone oils having a new functions imparted to an unmodified silicone oil by introducing various organic groups.

Examples of the unmodified silicone oil include dimethylpolysiloxane (e.g., BY27-001 described later), methylphenylpolysiloxane, methylhydrogen polysiloxane, fluoropolysiloxane, and the like.

Examples of the modified silicone oil include those having an organic functional group on the side chain of dimethylpolysiloxane, those having an organic functional group on the terminal of dimethylpolysiloxane, or those having an organic functional group on both the side chain and the terminal of dimethylpolysiloxane.

Specific examples include carbinol-modified dimethylpolysiloxanes, polyether-modified dimethylpolysiloxanes, amino-modified dimethylpolysiloxanes, epoxy-modified dimethylpolysiloxanes, carboxy-modified dimethylpolysiloxanes, methacryl-modified dimethylpolysiloxanes, mercapto-modified dimethylpolysiloxanes, phenol-modified dimethylpolysiloxanes, alkyl-group-modified dimethylpolysiloxanes, methylstyryl-group-modified dimethylpolysiloxanes, fluorine-modified dimethylpolysiloxanes, and the like.

The component (F) may be used alone or in combination of two or more.

When the component (F) is contained, the content of the component (F) is preferably 1.0 to 8.0 parts by mass, more preferably 2.0 to 7.0 parts by mass, still more preferably 3.0 to 6.0 parts by mass, and particularly preferably 4.0 to 5.0 parts by mass, based on 100 parts by mass of the component (A), from the viewpoint of water repellency.

From the viewpoint of flame retardancy, it is preferable that one embodiment of the flame-retardant resin composition of the invention further contain a brominated flame-retardant other than the component (B).

From the viewpoint of flame retardancy, the brominated flame-retardant other than the component (B) preferably contains one or more compounds selected from the group consisting of tris(tribromoneopentyl)phosphate, bis(3,5-dibromo-4-dibromopropyloxyphenyl)sulfone, 2,2-bis(4-hydroxyethoxy-3,5-dibromophenyl)propane, and tetrabromobisphenol-A-bis(2,3-dibromopropyl ether).

From the viewpoint of flame retardancy, the brominated flame-retardant other than the component (B) preferably contains tetrabromobisphenol-A-bis(2,3-dibromopropyl ether).

From the viewpoint of flame retardancy and light resistance, the content of bromine in the brominated flame-retardant other than the component (B) is preferably 45 to 80% by mass, and more preferably 65 to 74% by mass, based on 100% by mass of the entire brominated flame-retardant other than the component (B).

The content of bromine in the component (B) was obtained by determining the structural formula of the component (B) and calculating based on the molecular weight of the determined structural formula.

The brominated flame-retardant other than the component (B) may be used alone or in combination of two or more.

When the brominated flame-retardant other than the component (B) is contained, the content of the brominated flame-retardant other than the component (B) is preferably 1 to 30 parts by mass, more preferably 2 to 8 parts by mass, and still more preferably 4 to 6 parts by mass, based on 100 parts by mass of the component (A), from the viewpoint of flame retardancy. The content of the brominated flame-retardant other than the component (B) may be 2 to 10 parts by mass, 3 to 15 parts by mass, 4 to 10 parts by mass, or 5 to 8 parts by mass, from the viewpoint of flame retardancy.

When a brominated flame-retardant other than the component (B) is contained, from the viewpoint of flame retardancy and light resistance, a value obtained by dividing the content of the component (B) by the content of the brominated flame-retardant other than the component (B) is preferably 1 to 30, more preferably 1.2 to 20, still more preferably 1.5 to 10, particularly preferably 1.5 to 5.0, and most preferably 2.0 to 2.5.

One embodiment of the flame-retardant resin composition of the invention is essentially composed of components (A) to (D), and optionally, a component (E1), a component (E2), a component (F), and a brominated flame-retardant other than the component (B), and may contain other unavoidable impurities as long as the effect of the invention is not impaired.

For example, 80 to 100% by mass, 90 to 100% by mass, 95 to 100% by mass, 98 to 100% by mass, or 100% by mass of one embodiment of the flame-retardant resin composition of the invention may be composed of

components (A) to (D), or

a components (A) to (D), and optionally a component (E1), a component (E2), a component (F), and a brominated flame-retardant other than the component (B).

One embodiment of the flame-retardant resin composition of the invention can be produced, for example, by blending and melt-kneading components (A) to (D) and, if necessary, a component (E1), a component (E2), a component (F), and a brominated flame-retardants other than the component (B). For example, the above components can be blended and kneaded using a Henschel mixer, a Banbury mixer, a single-screw extruder, a twin-screw extruder, a multi-screw extruder, a co-kneader, or the like. The heating temperature during kneading is normally 160 to 250° C.

Further, the above components may be blended and premixed (pre-blended) by commonly used apparatus (e.g., a ribbon blender, a drum tumbler, or the like) and then kneaded by the above apparatus.

Examples of the shape of one embodiment of the flame-retardant resin composition of the invention include a pellet and the like.

One embodiment of the flame-retardant resin composition of the invention is preferably thermoplastic.

The molded body according to one aspect of the invention can be produced by using the flame-retardant resin composition described above.

Production of the molded body may be performed, for example, by injection molding, injection-compression molding, extrusion molding, blow molding, press molding, vacuum molding, foam molding, or the like.

One aspect of the molded body of the invention can be used as toilet parts such as a toilet seat and a toilet lid, and parts to which urine and stool, or alkaline detergents may adhere (e.g., a dirt bin, a toilet brush, a bathtub, a washbasin, a razor handle, a toothbrush handle, a washer tub of a washing machine, a washer skin of a washing machine, a drainage pan, a dishwasher, and a dish drier).

The toilet seat according to one aspect of the invention contains the molded body described above.

### EXAMPLES

The invention will be described using Examples, but the invention is not limited to the following Examples below. In addition, in the Examples and Comparative Examples, the blending amount of each component is shown in terms of parts by mass based on 100 parts by mass of the total of the component (A).

Note that each of the components used in the Examples and Comparative Examples is as follows.

The following were used as the component (A).

A1: J106MG (manufactured by Prime Polymer Co., Ltd., homopolypropylene, melt flow rate (MFR) at 230° C.: 15 g/10 min)
A2: J-6083HP (manufactured by Prime Polymer Co., Ltd., an ethylene-propylene block copolymer, MFR at 230° C.: 62 g/10 min)

The following was used as the component (B).

B1: PYROGUARD SR750 (manufactured by DKS Co. Ltd., tris(2,3-dibromopropyl) isocyanurate, content of bromine: 66% by mass)

The following was used as the component (C).

C1: TIPAQUE CR-60 (manufactured by ISHIHARASANGYO KAISHA, LTD., titanium oxide)

The following was used as the component (D).

D1: PATOX-MK (manufactured by NIHON SEIKO CO., LTD., diantimony trioxide)

The following was used as the component (E1).

E1-1: Tinuvin XT850FF (manufactured by BASF Japan Ltd., a mixture of a high molecular weight hindered amine light stabilizer and a steric hindered amine stabilizer)

The following was used as the component (E2).

E2-1: KEMISORB 114 (manufactured by CHEMIPRO KASEI KAISHA, LTD., 3,5-di-t-butyl-4-hydroxybenzoic acid hexadecyl ester)

The following was used as the component (F).

F1: BY27-001 (manufactured by Dow Corning Toray Co., Ltd., a mixture (kneaded product) of 50% by mass of polypropylene and 50% by mass of a silicone oil)

The following were used as a brominated flame-retardant other than the component (B).

B2: XZ-6800 (manufactured by Shouguang Ocean Chemical Co., Ltd., tetrabromobisphenol-A-bis(2,3-dibromopropylether), content of bromine: 68% by mass)
B3: CR-900 (manufactured by DAIHACHI CHEMICAL INDUSTRY CO., LTD., tris(tribromoneopentyl)phosphate, content of bromine: 71% by mass)

The MFR of the component (A) was measured in accordance with ASTM D-1238 (2013) at 230° C. and 2.16 kg.

The content of bromine in the component (B) was obtained by determining the structural formula of the component (B) and calculating based on the molecular weight of the determined structural formula.

### Examples 1 to 7 and Comparative Examples 1 to 3

### [Production of Flame-Retardant Resin Composition]

The components shown in Table 1 were respectively weighed in the blending amount shown in Table 1 and pre-blended. The pre-blended mixture was melt-kneaded using a twin-screw extruder TEM-30 (manufactured by The Japan Steel Works, Ltd.) with a screw diameter of 45 mm set at a cylinder temperature of 240° C., strand discharged from the die was cooled with a cooling bath, and the cooled strand was cut by a pelletizer to obtain pellets (a flame-retardant resin composition).

### [Production of Molded Body 1]

The obtained pellets were subjected to injection molding with an injection molding machine EC100 (manufactured by Toshiba Machinery Co., Ltd.) under conditions at a cylinder temperature of 210° C. and a mold temperature of 50° C. to obtain a molded body 1 (vertical burning test pieces having a size of 127 mm×12.7 mm and a thickness of 2.5 mm as defined in UL-94V).

### [Evaluation of Flame Retardancy]

The obtained molded body 1 was subjected to a 50 W (20 mm) vertical burning test according to UL-94V standard (UL-94V test) using HVUL plastic UL burning test chamber “Atlas” (manufactured by Toyo Seiki Seisaku-sho, Ltd.).

The flame retardancy of each of five test pieces was evaluated by means of the burning rank according to UL-94V standard to be assigned based on the burning times of the first and second tests, the presence or absence of cotton ignition, and the like. The results of flame retardancy and the burn times are shown in Table 1.

The highest burning rank is assigned as “V-0”, and the flame retardancy decreases as “V-1”, “V-2” sequentially. A case that does not correspond to any of the ranks “V-0” to “V-2” is defined as “not-V”.

### [Production of Molded Body 2]

The pellets described above were subjected to injection molding with an injection molding machine EC100 (manufactured by Toshiba Machinery Co., Ltd.) under conditions at a cylinder temperature of 210° C. and a mold temperature of 50° C. to obtain a molded body 2 (flat plates for evaluation having a size of 100 mm×100 mm and a thickness of 2 mm).

### [Evaluation of Light Resistance]

The color difference (hue change, ΔE) of the obtained molded body 2 was measured using the following apparatus under the following conditions, and the light resistance was evaluated. The results are shown in Table 1.

Apparatus: EYE Super UV Tester SUV-W151, manufactured by IWASAKI ELECTRIC Co., Ltd.
Light intensity: 90 mW/cm² (365 nm)
Black panel temperature during irradiation: 63° C.
Humidity during irradiation: 70%
Cycle: 6 hours (5 hours of irradiation and 1 hour of condensation)/1 cycle
Irradiation time: 100 hours
Measurement item: Hue change (ΔE) was measured using color computer.

### [Evaluation of Water Repellency]

On the surface of the obtained molded body 2, 3 μL of pure water was dropped, and the contact angle was measured at 25° C. by a 9/2 method using a contact angle meter DM500 (manufactured by Kyowa Interface Science Co., Ltd.) to evaluate water repellency of the molded body. The results are shown in Table 1.

### Control box: SA-30DM

Sliding unit: DM-SA
Single dispenser system: AD-31

TABLE 1

| | | | | | | | | | Comp. | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 1 | Ex. 2 | Ex. 3 |
| Component (A) | A1 | 50 | 50 | 50 | 50 | 50 | 50 | 50 | 50 | 50 | 50 |
| | A2 | 50 | 50 | 50 | 50 | 50 | 50 | 50 | 50 | 50 | 50 |
| Component (B) | B1 | 6 | 8 | 10 | 10 | 6 | 16 | 16 | 6 | — | — |
| Component (C) | C1 | 5 | 5 | 5 | 5 | 2 | 7 | 7 | 1 | — | — |
| Component (D) | D1 | 4 | 5 | 4 | 4 | 4 | 9 | 9 | 4 | 2 | 2 |
| Component (E1) | E1-1 | 0.4 | 0.4 | 0.4 | 0.6 | 0.4 | 0.7 | 0.4 | 0.4 | — | — |
| Component (E2) | E2-1 | 0.5 | 0.5 | 0.5 | 0.7 | 0.5 | 0.9 | 0.6 | 0.5 | — | — |
| Component (F) | F1 | 4 | 4 | 4 | 4 | 4 | 4 | 4 | 4 | 4 | 4 |
| Brominated flame-retardant | B2 | 4 | 5 | — | — | 4 | 7 | 7 | 4 | 3 | — |
| other than Component (B) | B3 | — | — | — | — | — | — | — | — | 2 | 5 |

| | | | | | | | | | | |
|---|---|---|---|---|---|---|---|---|---|---|
| Flame retardancy | V-2 | V-2 | V-2 | V-2 | V-2 | V-0 | V-0 | V-2 | V-2 | not-V |
| Burning time (s) | 12 | 8 | 12 | 10 | 11 | 4 | 2 | 10 | 115 | 120 |
| Light resistance | 1.4 | 1.2 | 1.1 | 1.0 | 8.2 | 0.9 | 1.2 | 15.0 | 33.0 | 12.7 |
| Water repellency (°) | 102 | 102 | 102 | 102 | 102 | 102 | 102 | 102 | 102 | 102 |

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A flame-retardant resin composition, comprising the following components (A) to (D), wherein
the content of the component (B) is 1 part by mass or more and 30 parts by mass or less based on 100 parts by mass of the component (A),
the content of the component (C) is 1.5 parts by mass or more and 10 parts by mass or less based on 100 parts by mass of the component (A), and
the content of the component (D) is 1 part by mass or more and 10 parts by mass or less based on 100 parts by mass of the component (A):
(A) polypropylene
(B) a brominated flame-retardant having an isocyanurate structure
(C) a pigment
(D) a flame-retardant synergist.

2. The flame-retardant resin composition according to claim 1, further comprising (E1) a hindered amine light stabilizer.

3. The flame-retardant resin composition according to claim 1, further comprising (E2) an ultraviolet absorber.

4. The flame-retardant resin composition according to claim 1, further comprising (F) a water repellent.

5. The flame-retardant resin composition according to claim 4, wherein the component (F) is a mixture of polypropylene and a silicone oil.

6. The flame-retardant resin composition according to claim 1, further comprising a brominated flame-retardant other than the component (B).

7. The flame-retardant resin composition according to claim 6, wherein a value obtained by dividing the content of the component (B) by the content of the brominated flame-retardant other than the component (B) is 1 or larger and 30 or smaller.

8. The flame-retardant resin composition according to claim 6, wherein the content of the brominated flame-retardant other than the component (B) is 1 part by mass or more and 30 parts by mass or less based on 100 parts by mass of the component (A).

9. The flame-retardant resin composition according to claim 6, wherein the content of bromine in the brominated flame-retardant other than the component (B) is 45% by mass or more and 80% by mass or less based on 100% by mass of the entire brominated flame-retardant other than the component (B).

10. The flame-retardant resin composition according to claim 6, wherein the brominated flame-retardant other than the component (B) is tetrabromobisphenol-A-bis(2,3-dibromopropylether).

11. The flame-retardant resin composition according to claim 1, wherein a melt flow rate of the component (A) measured at a condition of 230° C. and 2.16 kg is 1 g/10 min or lager and 60 g/10 min or smaller.

12. The flame-retardant resin composition according to claim 1, wherein the component (A) comprises homopolypropylene and a propylene-ethylene copolymer.

13. The flame-retardant resin composition according to claim 1, wherein the content of the component (B) is 10 parts by mass or more and 30 parts by mass or less based on 100 parts by mass of the component (A).

14. The flame-retardant resin composition according to claim 1, wherein the content of bromine in the component (B) is 45% by mass or more and 80% by mass or less based on 100% by mass of the entire component (B).

15. The flame-retardant resin composition according to claim 1, wherein the component (B) is tris(2,3-dibromopropyl)isocyanurate.

16. A molded body produced by using the flame-retardant resin composition according to claim 1.

17. A toilet seat comprising the molded body according to claim 16.
